(19) United States
(12) Patent Application Publication
(10) Pub. No.: US 2021/0165976 A1
(43) Pub. Date: Jun. 3, 2021

(54) SYSTEM AND METHOD FOR END TO END NEURAL MACHINE TRANSLATION

(71) Applicant: ELECTRONICS AND TELECOMMUNICATIONS RESEARCH INSTITUTE, Daejeon (KR)

(72) Inventors: Yo Han LEE, Siheung-si (KR); Young Kil KIM, Daejeon (KR)

(21) Appl. No.: 17/104,381

(22) Filed: Nov. 25, 2020

(30) Foreign Application Priority Data
Nov. 29, 2019 (KR) 10-2019-0156748

(51) Int. Cl. G06F 40/58; G06F 40/284; G06N 3/08

(52) U.S. Cl. CPC G06F 40/58; G06N 3/08; G06F 40/284

(57) ABSTRACT

Provided are a system and method for end-to-end neural machine translation. The method of end-to-end neural machine translation includes performing learning including a READ token on an end-to-end neural machine translation network, performing learning on an action network to learn a position of an actual segmentation point, and performing entire network re-learning on the end-to-end neural machine translation network and the action network.

### CROSS-REFERENCE TO RELATED APPLICATION

This application claims priority to and the benefit of Korean Patent Applications No. 10-2019-0156748, filed on Nov. 29, 2019, the disclosure of which is incorporated herein by reference in its entirety.

### BACKGROUND

### 1. Field of the Invention

The present invention relates to a system and method for end-to-end neural machine translation for real-time interpretation and translation.

### 2. Description of Related Art

In an end-to-end neural machine translation model, in order to translate a first language sentence into a second language sentence, the first language sentence is input to the end, after which a second language token (a word) is generated one by one so that the second language sentence is completed.

Such a conventional neural machine translation model is required to wait until a sentence utterance is finished, and thus there is a difficulty in being applied to a situation where real-time interpretation and translation is required, such as a conference or lecture.

Therefore, the end-to-end neural machine translation model for real-time interpretation and translation should perform translation in appropriate communication units, rather than in sentence units.

The translation in communication units is performed by a process of outputting a translation at a point in time where a meaning is formed before an utterance of a first language sentence ends, and then continuing reception of first language token words until a communicative meaning is formed again and outputting a translation corresponding thereto.

Since data for training the end-to-end neural machine translation model is composed of units of sentences, there is a need for an improved neural machine translation model for learning translation in communication units.

### SUMMARY OF THE INVENTION

The present invention provides a system and method for end-to-end neural machine translation that are capable of performing translation in communication units in a situation, such as a conference or lecture, where real-time interpretation and translation is required.

The technical objectives of the present invention are not limited to the above, and other objectives may become apparent to those of ordinary skill in the art on the basis of the following description.

According to an aspect of the present invention, there is provided a system for end-to-end neural machine translation, the system including an inputter configured to receive a first language input token, a memory in which a real time interpretation and translation program for the first language input token is stored, and a processor configured to execute the program, wherein the processor combines an output of a translation network with an output of an action network to compose a final translation result in communication units.

According to another aspect of the present invention, there is provided a method of end-to-end neural machine translation, the method including the steps of (a) adding a READ token and performing learning on an end-to-end neural machine translation network, (b) performing learning on an action network to learn a position of an actual segmentation point, and (c) performing entire network re-learning on the end-to-end neural machine translation network and the action network.

### BRIEF DESCRIPTION OF THE DRAWINGS

FIGS. 1 and 2 illustrate a system for end-to-end neural machine translation according to an embodiment of the present invention.

FIG. 3 illustrates a method of end-to-end neural machine translation according to an embodiment of the present invention.

FIG. 4 illustrates reward for an action sequence output from the system for neural machine translation according to the embodiment of the present invention.

FIG. 5 is a view illustrating an example of a computer system in which a method according to an embodiment of the present invention is performed.

### DETAILED DESCRIPTION OF EXEMPLARY EMBODIMENTS

Hereinafter, the above and other objectives, advantages and features of the present invention and manners of achieving them will become readily apparent with reference to descriptions of the following detailed embodiments when considered in conjunction with the accompanying drawings.

However, the scope of the present invention is not limited to such embodiments, and the present invention may be embodied in various forms. The embodiments to be described below are provided only to assist those skilled in the art in fully understanding the objectives, constitutions, and the effects of the invention, and the scope of the present invention is defined only by the appended claims.

Meanwhile, terms used herein are used to aid in the explanation and understanding of the present invention and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

The conventional end-to-end neural machine translation model is provided to, after a first language sentence is input to the end, output a second language sentence. Accordingly, a great delay time occurs in a real-time interpretation and translation situation, and when a translation is performed before the first language sentence is completed, to reduce the delay time, the translation performance is greatly lowered due to a difference between a learning situation and an inference situation.

The present invention has been proposed to alleviate the above-described limitations of the conventional technology and proposes a system and method for end-to-end neural machine translation for performing translation in communication units, and to this end, proposes a system for end-to-end neural machine translation including an end-to-end neural machine translation network and an action network for learning in communication units.

In order to train a system for neural machine translation, a sentence-unit parallel corpus including a first language text and a second language text is required.

In order to provide an interpretation and translation service in an actual environment, a speech recognition module converts a speech signal uttered in real time into text, and the system for neural machine translation allows a text resulting from translating the converted text in communication units to be output as an utterance through a speech synthesis module.

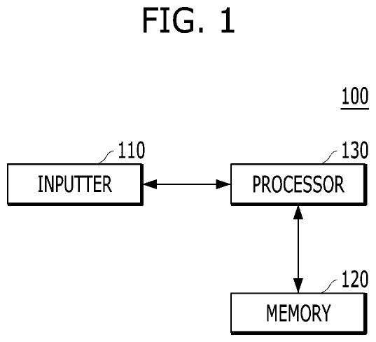

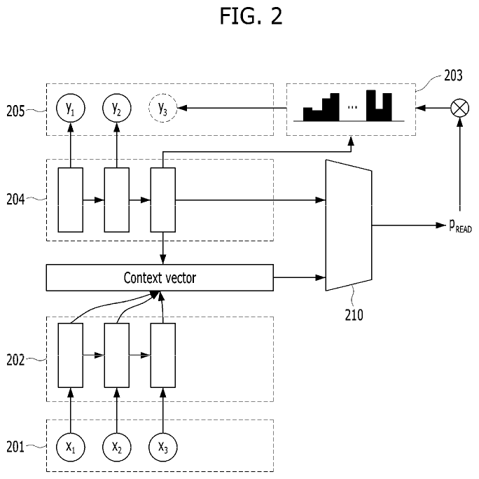

FIGS. 1 and 2 illustrate a system for end-to-end neural machine translation according to an embodiment of the present invention.

A system 100 for end-to-end neural machine translation according to the present invention includes an inputter 110 configured to receive first language input tokens, a memory 120 in which a real time interpretation and translation program for the first language input tokens is stored, and a processor 130 configured to execute the program, wherein the processor 130 combines outputs of a translation network and an action network to compose a final translation result in communication units.

The translation network has an encoder-decode structure to which an attention mechanism is coupled and generates an action sequence by adding a READ token at an arbitrary position in a second language sentence of training data.

The action network determines whether to further read the first language input token or generate a second language output token on the basis of translation information having been input and output so far.

The processor 130 learns the position of an actual segmentation point generated in real time interpretation and translation through the action network and performs learning on the action network through reinforcement learning having a reward function using a second language sentence and a second language token sequence.

The action network outputs a probability of a READ action using a context vector and a hidden state vector, and the processor 130 calculates a probability distribution of final token generation using a probability distribution of output token generation, a delta probability distribution of a READ action, a probability of a READ action, and a probability of a WRITE action.

The end-to-end neural machine translation network that composes the system for neural machine translation has an encoder-decoder structure coupled with an attention mechanism, which is the most widely used recently as an end-to-end neural network structure.

The action network determines whether to further read the first language input token (READ) or generate the second language output token (WRITE) based on translation information having been input and output so far.

The translation information having been input and output so far may be expressed as an encoder context vector and a decoder hidden state vector of the end-to-end neural machine translation network, and the action network may be composed of a neural network, such as a deep neural network or a recurrent neural network, that receives the translation information and outputs a probability of a READ action being performed.

The probability of a WRITE action is obtained as a value of 1 minus the probability of a READ action being performed.

Referring to FIG. 2, the neural machine translation model expresses a first language token (x₁, x₂, x₃) of an input buffer 201 as a hidden state through an encoder network 202 and allows the hidden state to be subject to an attention mechanism operation with a hidden state of a decoder network 204 to generate a current context vector.

An action network 210 receives the calculated context vector and the decoder's hidden state vector as inputs, and outputs a probability p_{READ} of the READ action.

The probability distribution of output token generation at each decoding step is calculated from a hidden state of the decoder in the corresponding step.

The output token includes predefined second language tokens and a READ token.

A final token generation probability distribution 203 is calculated by a weighted sum of the probability of the WRITE/READ action with the probability distribution of output token generation and the delta probability distribution of the READ action calculated by the neural machine translation network.

p_{vocab}=p_{vocab}^{nmt}*(1−p_{READ})+ [symbol] (y=READ)*p_{READ} [Equation 1]

In Equation 1, (y=READ) refers to the delta probability distribution of the READ token.

When the probability of READ token generation is the largest in the final token generation probability distribution 203, a newly inputted first language token is added to the input buffer 201.

When the probability of second language token generation is the largest in the final token generation probability distribution 203, an output token is stored in an output buffer 205 and then the same process as the above is performed in the next decoding step.

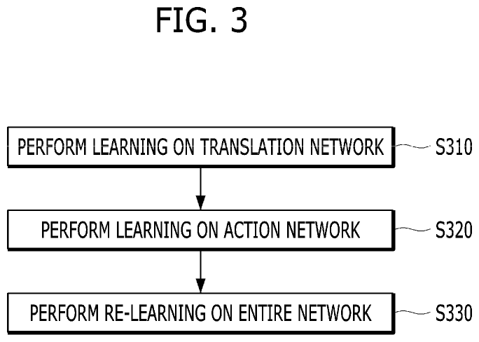

FIG. 3 illustrates a method of end-to-end neural machine translation according to an embodiment of the present invention.

The method of end-to-end neural machine translation according to the present invention includes performing learning on an end-to-end neural machine translation network by including a READ token (S310), performing learning on an action network to learn the position of an actual segment point (S320), and performing entire network re-learning on the end-to-end neural machine translation network and the action network.

In operation S310, learning is performed on the end-to-end neural machine translation network having an encoder-decoder structure to which an attention mechanism is coupled.

In operation S310, an action sequence is generated by adding READ tokens corresponding in number to the length of a first language sentence at arbitrary positions of a second language sentence of training data.

In operation S320, it is determined whether to further read the first language input token or generate a second language output token on the basis of input/output translation information.

The input/output translation information is expressed as an encoder context vector and a decoder hidden state vector of the end-to-end neural machine translation network.

In operation S320, the probability distribution of output token generation is fixed and the probability of a READ action is learned.

In operation S320, learning is performed on the action network through reinforcement learning using a second language sentence and a second language token sequence.

In operation S330, the probability distribution of output token generation and the probability of a READ action are simultaneously learned.

In the conventional end-to-end neural machine translation network, learning is performed by outputting a second language token after the entire first language sentence is input. However, in a real-time interpretation and translation situation, the translation network needs to output the second language token before the first language sentence is completed, which causes a difference between the learning situation and the inference situation.

Therefore, in operation S310 of performing learning on the translation network according to the present invention, in order to reflect the inference situation in the learning, the READ tokens corresponding in number to the length of the first language sentence are added at arbitrary positions of the second language sentence of training data to generate an action sequence.

The READ token may be added according to various rules. For example, the READ token may be added to the second language sentence such that the probability of appearance of the READ token increases in a direction toward the beginning of the sentence and decreases in a direction toward the end of the sentence (the conventional learning method allows all READ tokens to be placed in the beginning of the sentence).

In the case of using the probabilistic method, N action sequence samples are extracted for one sentence to prevent bias in the training data.

In the method of adding a READ token, the READ token is added at an arbitrary position in the second language sentence which may be different from the position of a segmentation point (a part at which WRITE is performed after READ) that occurs in actual real-time interpretation and translation.

According to the embodiment of the present invention, the system for neural machine translation for real-time interpretation and translation is constructed by adding the action network for learning the position of an actual segmentation point to the learned translation network.

In operation 320 of performing learning on the action network, for stable learning, the translation network learned in advance is fixed, and the action network is learned through reinforcement learning having a reward function as shown in Equation 2 below.

$${r}_{t} = \{ \begin{matrix}score ( Y , {Y}^{*} ) if & ( {a}_{t - 1} = W , {a}_{t} = R ) or t = T \\ 0 & otherwise\end{matrix} \qquad [ Equation 2 ]$$

In Equation 2, Y* denotes a given second language sentence (a reference sentence), and Y denotes a second language token sequence generated until step t by the system for neural machine translation.

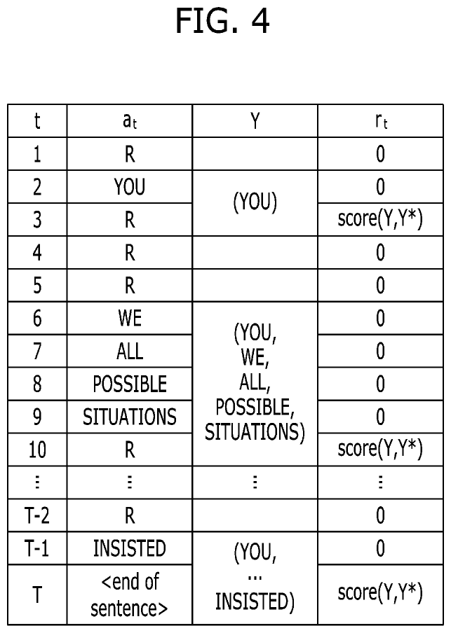

FIG. 4 shows a reward for an action sequence output from the system for neural machine translation according to the embodiment of the present invention, specifically, a reward for an action sequence with respect to a reference sentence “You insisted that we must be able to mathematically identify the action of an AI in all possible situations,” output from the system for neural machine translation.

A reward rt is calculated by a method of measuring the similarity between sentences, such as bilingual evaluation understudy (BLEU) and national institute of standards and technology (NIST).

An action network π is trained in a direction of maximizing an objective function for a decay cumulative reward and uses policy gradient based algorithms, such as REINFORCE and Actor-Critic.

J=E_{π}[Σₜ₌₁^{T}γ^{t-1}rₜ] [Equation 3]

In Equation 3, γ is a decay factor that attenuates the importance of a future reward and is set to be greater than 0 and less than or equal to 1.

The decay factor γ determines a translation accuracy and a delay time that are in a trade-off relationship.

Since the reward is given when a READ token is generated after WRITE, the action network is highly likely to repeat WRITE and READ, and in this case, the translation delay time may decrease, but the accuracy may decrease.

Therefore, when the decay factor γ is set to be close to 1, the importance for a future reward increases so that the accuracy is increased while the translation delay time is lengthened, and when the decay factor γ is set to close to 0, the accuracy is lowered while the translation delay time is shortened.

Since the translation network learns real-time interpretation and translation from arbitrary segment points, and the action network learns segment points through the reward function, the real-time interpretation and translation performance may be lowered due to a difference in segment position between the two networks.

According to the embodiment of the present invention, operation S330 (the entire network re-learning) simultaneously performing learning on the translation network and the action network, unlike operation S320 (the action network learning) in which learning is performed only on the action network by fixing the translation network, is performed to thereby construct an end-to-end neural machine translation model for real time interpretation and translation.

When the process shown in FIG. 3 is interpreted in view of Equation 1 described above, operation S310 (the translation network learning) is an operation of pre-learning p_{vocab}^{nmt} of the right side in Equation 1], and operation S320 (the action network learning) is an operation of learning p_{READ} after fixing p_{vocab}^{nmt}, and operation S330 (the entire network re-learning) is an operation of simultaneously learning p_{vocab}^{nmt} and p_{READ}.

Meanwhile, the method of end-to-end neural machine translation according to the embodiment of the present invention may be implemented in a computer system or may be recorded on a recording medium. The computer system may include at least one processor, a memory, a user input device, a data communication bus, a user output device, and a storage. The above described components perform data communication through the data communication bus.

The computer system may further include a network interface coupled to a network. The processor may be a central processing unit (CPU) or a semiconductor device for processing instructions stored in the memory and/or storage.

The memory and the storage may include various forms of volatile or nonvolatile media. For example, the memory may include a read only memory (ROM) or a random-access memory (RAM).

Accordingly, the method of end-to-end neural machine translation according to the embodiment of the present invention may be implemented in the form executable by a computer. When the method of end-to-end neural machine translation according to the embodiment of the present invention is performed by the computer, instructions readable by the computer may perform the method of end-to-end neural machine translation according to the present invention.

Meanwhile, the method of end-to-end neural machine translation according to the present invention may be embodied as computer readable codes on a computer-readable recording medium. The computer-readable recording medium is any recording medium that can store data that can be read thereafter by a computer system. Examples of the computer-readable recording medium include a ROM, a RAM, a magnetic tape, a magnetic disk, a flash memory, an optical data storage, and the like. In addition, the computer-readable recording medium may be distributed over network-connected computer systems so that computer readable codes may be stored and executed in a distributed manner.

As is apparent from the above, the prevent invention can provide the system and method for end-to-end neural machine translation that are suitable for a real-time interpretation and translation situation in which a translated text needs to be output before completion of an utterance, such as a conference or lecture.

According to an embodiment of the present invention, the prevent invention includes a translation network that is learned in a manner similar to a real-time interpretation and translation situation, and an action network that learns appropriate segment points from an inner state of the translation network and a reward function, thereby ensuring higher translation performance in a real time interpretation and translation situation with a lower delay time compared to the conventional neural machine translation model.

The effects of the present invention are not limited to those mentioned above, and other effects not mentioned above will be clearly understood by those skilled in the art from the above detailed description.

Although the present invention has been described with reference to the embodiments, a person of ordinary skill in the art should appreciate that various modifications, equivalents, and other embodiments are possible without departing from the scope and spirit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

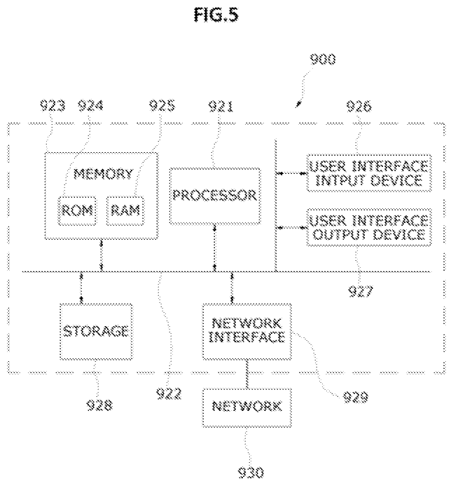

The method according to an embodiment of the present invention may be implemented in a computer system or may be recorded in a recording medium. FIG. 5 illustrates a simple embodiment of a computer system. As illustrated, the computer system may include one or more processors 921, a memory 923, a user input device 926, a data communication bus 922, a user output device 927, a storage 928, and the like. These components perform data communication through the data communication bus 922.

Also, the computer system may further include a network interface 929 coupled to a network. The processor 921 may be a central processing unit (CPU) or a semiconductor device that processes a command stored in the memory 923 and/or the storage 928.

The memory 923 and the storage 928 may include various types of volatile or non-volatile storage mediums. For example, the memory 923 may include a ROM 924 and a RAM 925.

Thus, the method according to an embodiment of the present invention may be implemented as a method that can be executable in the computer system. When the method according to an embodiment of the present invention is performed in the computer system, computer-readable commands may perform the producing method according to the present invention.

The method according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

The technical objectives of the present invention are not limited to the above, and other objectives may become apparent to those of ordinary skill in the art based on the specification.

Although the present invention has been described with reference to the embodiments, a person of ordinary skill in the art should appreciate that various modifications, equivalents, and other embodiments are possible without departing from the scope and spirit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A system for end-to-end neural machine translation, comprising:
an inputter configured to receive a first language input token;
a memory in which a real time interpretation and translation program for the first language input token is stored; and
a processor configured to execute the program,
wherein the processor combines an output of a translation network with an output of an action network to compose a final translation result in communication units.

2. The system of claim 1, wherein the translation network has an encoder-decoder structure to which an attention mechanism is coupled.

3. The system of claim 1, wherein the translation network adds a READ token at an arbitrary position of a second language sentence of training data to generate an action sequence.

4. The system of claim 1, wherein the action network determines whether to further read the first language input token or generate a second language output token on the basis of translation information having been input and output so far.

5. The system of claim 1, wherein the processor learns a position of an actual segmentation point that occurs in a real time interpretation and translation through the action network.

6. The system of claim 5, wherein the processor performs learning on the action network through a reinforcement learning having a reward function using a second language sentence and a second language token sequence.

7. The system of claim 1, wherein the action network outputs a probability of a READ action using a context vector and a hidden state vector.

8. The system of claim 7, wherein the processor calculates a probability distribution of final token generation using a probability distribution of output token generation, a delta probability distribution of a READ action, a probability of a READ action, and a probability of a WRITE action.

9. A method of end-to-end neural machine translation, comprising the steps of:
(a) adding a READ token and performing learning on an end-to-end neural machine translation network;
(b) performing learning on an action network to learn a position of an actual segmentation point; and
(c) performing entire network re-learning on the end-to-end neural machine translation network and the action network.

10. The method of claim 9, wherein the step (a) includes performing learning on the end-to-end neural machine translation network having an encoder-decoder structure to which an attention mechanism is coupled.

11. The method of claim 9, wherein the step (a) includes adding READ tokens corresponding in number to a length of a first language sentence at arbitrary positions of a second language sentence of training data to generate an action sequence.

12. The method of claim 9, wherein the step (b) includes determining whether to further read a first language input token or generate a second language output token on the basis of translation information having been input and output.

13. The method of claim 12, wherein the translation information having been input and output is expressed as an encoder context vector and a decoder hidden state vector of the end-to-end neural machine translation network.

14. The method of claim 9, wherein the step (b) includes fixing a probability distribution of output token generation and learning a probability of a READ action.

15. The method of claim 14, wherein the step (b) includes learning on the action network through a reinforcement learning using a second language sentence and a second language token sequence.

16. The method of claim 14, wherein the step (c) includes simultaneously learning the probability distribution of output token generation and the probability of a READ action.
